(19) United States
(12) Patent Application Publication
(10) Pub. No.: US 2009/0082963 A1
(43) Pub. Date: Mar. 26, 2009

(54) VEHICLE LOCATOR

(76) Inventor: Tetsuro Motoyama, Cupertino, CA (US)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/861,875

(22) Filed: Sep. 26, 2007

(51) Int. Cl. G01C 21/00; G06F 17/00; G08G 1/123

(52) U.S. Cl. 701/213; 340/993; 701/207

(57) ABSTRACT

A location apparatus for guiding a user to a location, including: a system unit configured to determine a current location using radio signals; a user interface unit having a display area and a button; a memory unit; a processor configured store a first location in the memory unit in response to receiving a signal from a vehicle indicating that an engine of the vehicle is off, and a computational unit configured to interact with the button, wherein the computation unit retrieves a second location from the system unit and calculates a relative three-dimensional direction from the second location to the first location upon selection of the second button by the user, wherein the relative three-dimensional direction is graphically represented on the display area of the user interface unit.

### CROSS-REFERENCE TO RELATED APPLICATIONS

This is related to the following U.S. application Ser. No. 09/575,702 filed on Jul. 12, 2000, now U.S. Pat. No. 6,421,608; Ser. No. 10/167,497 filed on Jun. 13, 2002; Ser. No. 09/575,710 filed on Jul. 25, 2000; Ser. No 09/668,162 filed on Sep. 25, 2000, now U.S. Pat. No. 6,857,016; Ser. No. 10/636,561, filed on Aug. 8, 2003, now U.S. Pat. No. 7,158,079; Ser. No. 11/109,640, filed on Apr. 20, 2005, application Ser. No. 11/586,537, filed on Oct. 26, 2006, and attorney docket number 304406US, filed on ______. The contents of each of the above applications are incorporated herein by reference.

### BACKGROUND OF THE INVENTION

1. Field of the Invention

The present invention relates generally to an electronic key to a vehicle that registers a position of the vehicle, and more specifically to a location system and method using radio-based technology to register a location and then later direct a user back to the registered location.

2. Discussion of the Background

Today, many people have trouble remembering how to return to a particular location such as a common meeting place or where they parked their vehicle. This problem will most likely only get worse as the population ages and the aging generation face problems associated with memory loss. Forgetting where a vehicle is parked can be a serious problem in large parking lots such as malls, shopping centers, airport, or amusement parks.

The Global Positioning System (GPS) is an example of a radio-based technology that is used to provide an earth based position using orbiting space satellites. As is well known in the art, currently there are twenty-four GPS space satellites in the GPS constellation orbiting in twelve-hour orbits, 20,200 kilometers above Earth configured such that there are six to eleven GPS satellites visible from any point on the Earth. GPS satellites broadcast specially coded signals that can be processed by GPS receivers. These GPS space satellites transmit on a primary and a secondary radio frequency, referred to as L1 and L2. The frequency of L1 is 1575.42 MHz (154 times the atomic clock) and the frequency of L2 is 1227.6 MHz (120 times the atomic clock). A typical GPS receiver retrieves GPS signals from at least three orbiting GPS space satellites and then calculates an earth based location, generally latitude and longitude coordinates. GPS signals from at least four orbiting GPS space satellites are necessary to calculate a three-dimensional earth based location, such as latitude, longitude and altitude. A GPS receiver calculates its location by correlating the signal delays from the GPS space satellites and combining the result with orbit-correction data sent by the satellites.

At present, there exist many different types of GPS receivers of varied capabilities which are commonly available for personal and governmental use. Typically, these GPS receivers are intended for navigational use in which the current calculated latitude and longitude location is displayed on some form of a geographic or topographical map. These systems are sometimes bulky and may require the user to manually program the system, such as entering a destination street address.

Because a typical user of a device intended to help the user remember how to return to a parked car location is likely to be concerned about the complexity of the device, the device should be simple to operate. Thus, a location device should have a simple user interface that is easy to operate with no user programming required. To this end, the location device should be able to utilize radio-based technology to automatically determine its current location.

Thus, there exists an unmet need in the art for a lightweight and simple to use location device for registering and returning to a particular location.

### SUMMARY OF THE INVENTION

In one aspect of the present invention, a location apparatus for guiding a user to a location, includes: a system unit configured to determine a current location using radio signals; a user interface unit having a display area and a button; a memory unit; a processor configured store a first location in the memory unit in response to receiving a signal from a vehicle indicating that an engine of the vehicle is off; and a computational unit configured to interact with the button, wherein the computation unit retrieves a second location from the system unit and calculates a relative three-dimensional direction from the second location to the first location upon selection of the second button by the user, wherein the relative three-dimensional direction is graphically represented on the display area of the user interface unit.

Another aspect of the present invention involves a method for guiding a user to a location, including: storing a first location in a memory unit in response to receiving a signal from a vehicle indicating that an engine of the vehicle is off; determining a second location; calculating a relative three-dimensional direction from the second location to the first location; and graphically representing a relative three-dimensional direction on a display device.

Another aspect of the present invention involves a computer readable storage medium, encoded with instructions which when executed by a computer causes the computer to implement a method for guiding a user to a location, including: storing a first location in a memory unit in response to receiving a signal from a vehicle indicating that an engine of the vehicle is off; determining a second location; calculating a relative three-dimensional direction from the second location to the first location; and graphically representing a relative three-dimensional direction on a display device.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a person looking for his vehicle in a parking lot;

FIG. 2 is a block diagram of a location device according to an embodiment of the present invention;

FIG. 3 is an example of the location device implemented in an electronic vehicle key according to an embodiment of the present invention;

FIG. 4 is a flowchart illustrating the steps of registering a location according to an embodiment of the present invention;

FIG. 5A-5C are examples of the location device incorporating a simple route-tracking mechanism according to alternate embodiments of the present invention;

FIG. 6 is a flow chart illustrating the step of locating a vehicle using an embodiment of the present invention;

FIG. 7 is a flow chart illustrating the steps of an engine shutoff sequence of a vehicle;

FIG. 8 is an example of another implementation of the present invention; and

FIG. 9 is an example of another implementation of the present invention.

### DETAILED DESCRIPTION OF THE PREFERRED EMBODIMENTS

Referring now to the drawings, wherein like reference numerals designate identical or corresponding parts throughout the several views.

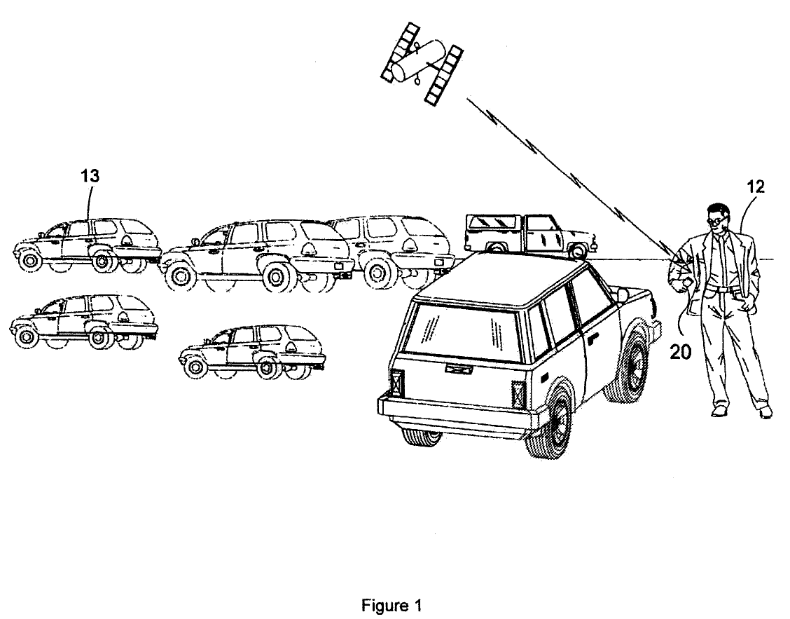

Referring to FIG. 1, a person 12 is attempting to locate his vehicle 13 in a parking lot by using his electronic key 20, which has GPS capability. Electronic Key 20 is not a conventional metal key with teeth. An electronic key, as used in the present application, refers to an electronic key used to remotely start a vehicle or used, in part, to start a vehicle without inserting a conventional metal key into the ignition. An example of an electronic key, as used herein, is an electronic device used in connection with a vehicle with a start/stop button or switch. Alternative embodiments of the present invention use a conventional metal key with teeth and a remote access device.

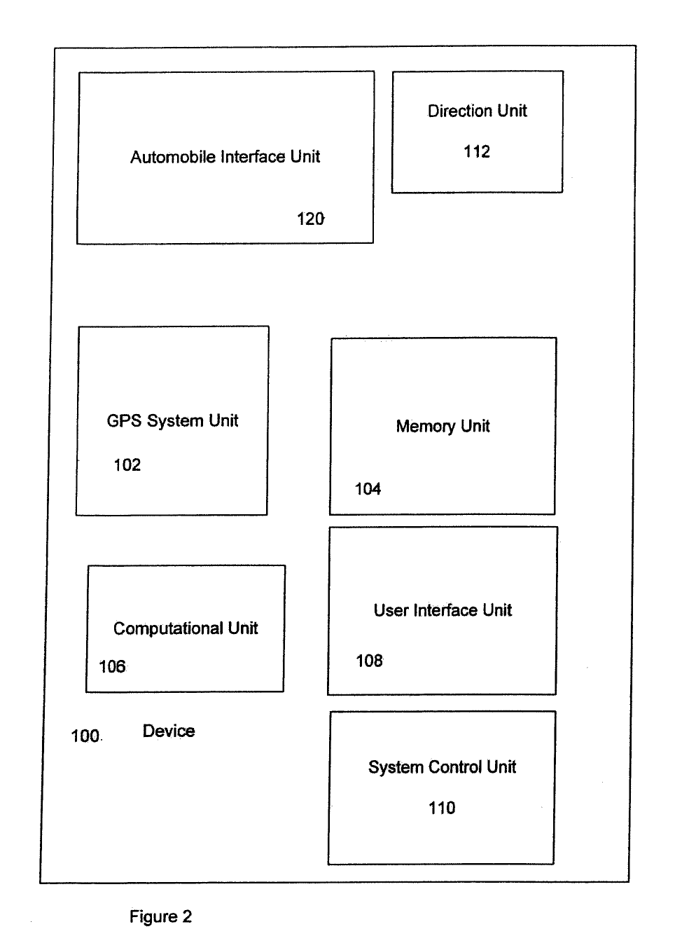

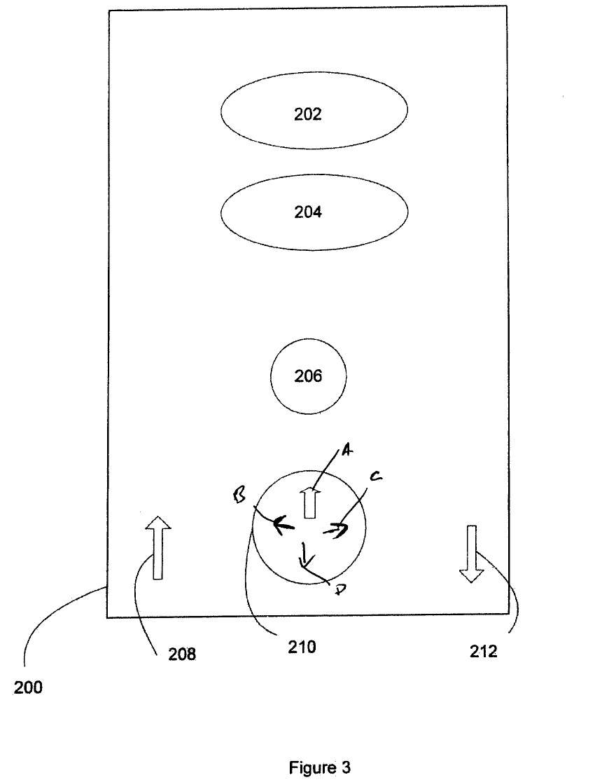

Referring to FIG. 2, a block diagram of the location device according to an embodiment of the present invention is shown. The location device 100 contains seven major subunits (102, 104, 106, 108, 110, 112, and 120). Location device 100 is a non-limiting example of electronic key 20 shown in FIG. 1. GPS System Unit 102 contains a radio frequency receiver along with a system bus interface, not described, and computer software. The radio frequency receiver receives radio frequency signals from radio-based transmitters (e.g., GPS satellites or ground stations). These radio frequency signals are used by the computer software to calculate a current three-dimensional location of the location device. Memory unit 104 contains the non-volatile and volatile memory that is required to operate the location device and its associated software. Memory Unit 104 may contain dynamic RAM and flash memory along with ROM. Computational Unit 106 includes a CPU which may be implemented as any type of processor including commercially available microprocessors from companies such as Intel, AMD, Motorola, Hitachi and NEC. The Computational Unit 106 is configured to store a three-dimensional location ascertained from the GPS System Unit 102 into Memory Unit 104, to compute a relative three-dimensional direction of the current location of the device relative to the stored location, and to communicate this directional information to User Interface Unit 108. User Interface Unit 108 contains the control logic of the display unit and buttons. User interface 108 detects a pressing of a button on the location device 100, and identifies the function requested by user for the control unit 110 to perform. In addition, the user interface unit 108 receives directional information and controls the display so as to indicate the direction to the car using display 208 of FIG. 3 (which is described later).

Non-limiting embodiments of the location device have low power requirements. In some non-limiting embodiments of the present invention, the display is a low-power display, such as an LED type display or small LCD display used in a watch, and not, e.g., a large LCD display used in PDA or a Laptop computer display. However, the present invention is equally useable with any size display.

The location device 100 also includes a vehicle or automobile interface unit 120. Vehicle interface unit 120 interfaces with the vehicle to send and receive signals. For example, vehicle interface unit 120 will send the door lock and open signals to the vehicle. In addition, vehicle interface unit 120 receives a signal to record the current location into memory unit 104. For example, vehicle interface 120 can receive a signal to automatically record the position of the vehicle from a GPS system when the engine is stopped by pressing the stop button or switch in the vehicle. A wireless communication module, such as Bluetooth or wireless USB can be used to communicate with the vehicle, to receive the engine shutdown signal, and to acquire the parked location. This embodiment automatically stores the location of the vehicle and relieves the user of having to remember to store there vehicle's location. Direction unit 112 is used to identify the direction from device 100 to vehicle 13 so that display 210 (described later) will display an arrow relative to front, back, left, and right, wherein button 202 of FIG. 3 defines a front direction.

Referring to FIG. 3, an example of the location device implemented in an electronic vehicle key according to an embodiment of the present invention is shown. In this embodiment, a vehicle key performs normal vehicle key operations in addition to the location operations of the present invention. For instance, door lock button 202 locks the vehicle doors, and unlock button 204 unlocks the vehicle doors. As known to persons of ordinary skill in the art, additional functional buttons can be included. Button 206 is used to locate the user's vehicle. In response to button 206 being pushed, a direction to the car will be shown on display 210 along with indicators 208 and 212. One of arrows A-D on display 210 will be illuminated to identify that the user's vehicle is located forward, backward, left, or right. Arrow 208 is illuminated to indicate that the user's car is located above the user. For example, arrow 208 would be illuminated when the user's vehicle is located on a higher level of a parking garage. Arrow 212 is illuminated to indicate that the user's car is located below the user. For example, arrow 212 would be illuminated when the user's vehicle is located on a lower level of a parking garage. In additional embodiments of the present invention, button 206 is also used to initiate registration of a location (i.e., the pressing of button 206 causes the present three-dimensional location to be stored). However, as will be appreciated by those of ordinary skill in the art, registration may be done with a function specific button.

When the user presses button 206, the current three-dimensional location of the location device is ascertained from the radio-based system unit 102 and stored in memory unit 108. Activation of the directional indicators is also initiated when the user presses button 206. The current three-dimensional location of the location device is again ascertained from the radio-based system unit 102. Next, a relative three-dimensional direction is computed from the current location to the previously registered location. The relative three-dimensional direction is then displayed using directional indicators (208, 210 and 212). A user is directed towards a registered location using forward 210a, left 210b, right 210c, back 210d, up 208 and down 212 LED indicators. Up 208 and down 212 indicators are used to indicate the registered location altitude relative to the current altitude of the location device. Thus, if the registered location is higher or lower relative to the current altitude of the location device, this difference is indicated by up 208 and down 212 indicators, respectively. Each successive time that button 206 is pressed results in the recalculation and display of the relative three-dimensional direction from the current location to the registered location.

Optionally, the location device may be configured to periodically calculate and display, for some predetermined period of time after pressing button 206, the relative three-dimensional direction from the current location to the registered location. Additionally, indicators 208, 210 and 212 may optionally be configured with labels indicating their function.

It is to be understood that FIG. 3 illustrates just one of the many possible embodiments of the location device and that numerous variations are possible without departing from the scope of the present invention. It is also understood that FIG. 3 is an example of a location device incorporated into an electronic vehicle key. Also, the directions can be displayed by more than 4 indicators for finer directional indication. Alternatively, a digital display may be used that shows an arrow that can rotate in a continuous manner.

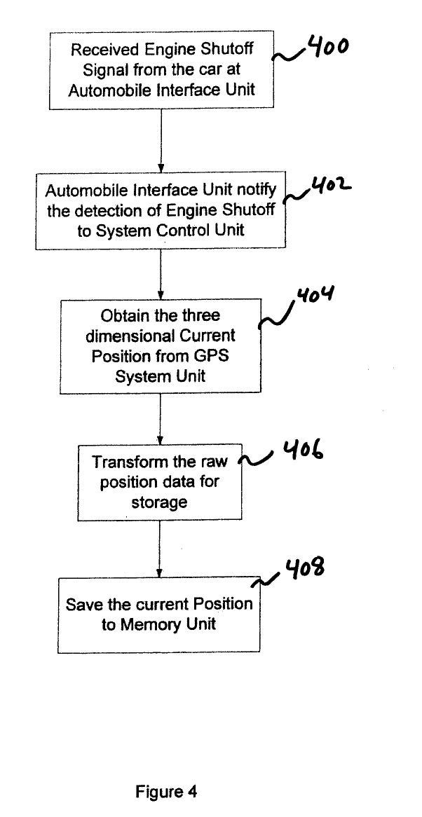

Referring to FIG. 4, a flowchart of the steps for registering a location according to an embodiment of the present invention is shown. In step 400, the vehicle interface unit of the electronic key receives an engine shutoff signal from the vehicle when the engine is shutoff. In step 402, the vehicle interface unit sends the engine shutoff signal to system control unit 110 of the vehicle key. In step 404, the system control unit obtains the three dimensional current position from the GPS System Unit 102. GPS System Unit 102 may ascertain the current three-dimensional location from the radio-based system unit using an internal radio frequency receiver in communication with radio-based transmitters (e.g., at least four orbiting GPS space satellites or ground stations). This operation will continue, for a predetermined number of attempts, until the current three-dimensional location is ascertained by the radio frequency receiver. In step 406, the system control unit 110 transforms the position data for storage in a convenient format. At step 408, the System Control unit 110 overwrites the current position information into the Memory Unit 104.

Thus, in the embodiment shown in FIG. 4, a user does not have to push a button to record the position of the vehicle. Rather, the electronic key device automatically stores the location of the vehicle in response to a signal indicating that the engine of the vehicle has been turned off.

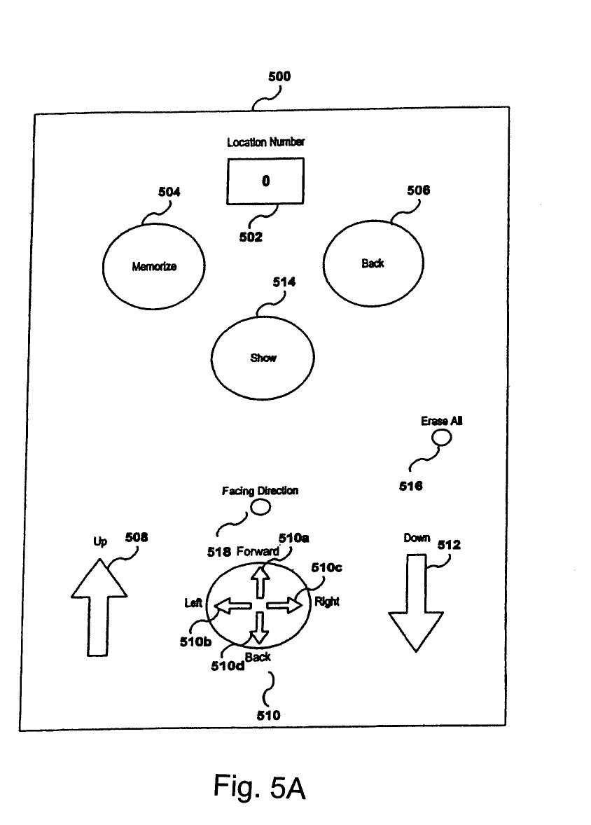

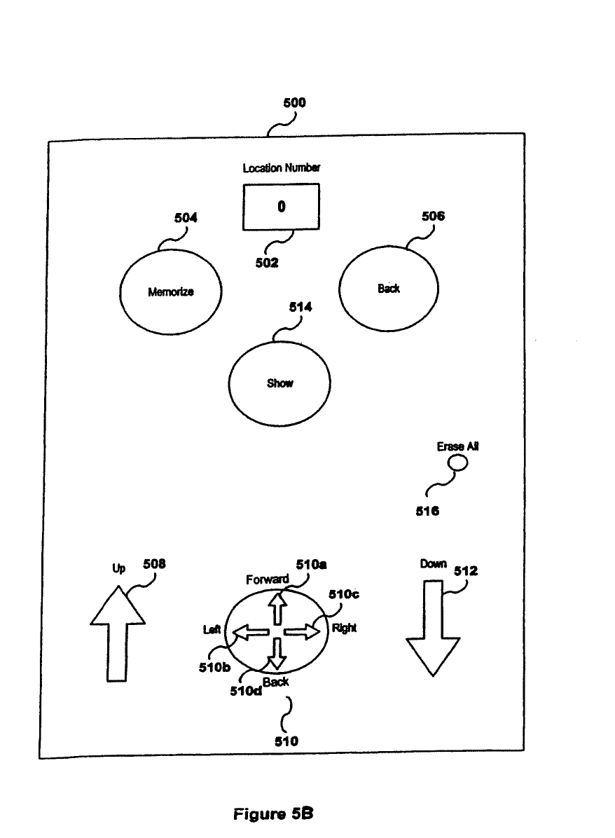

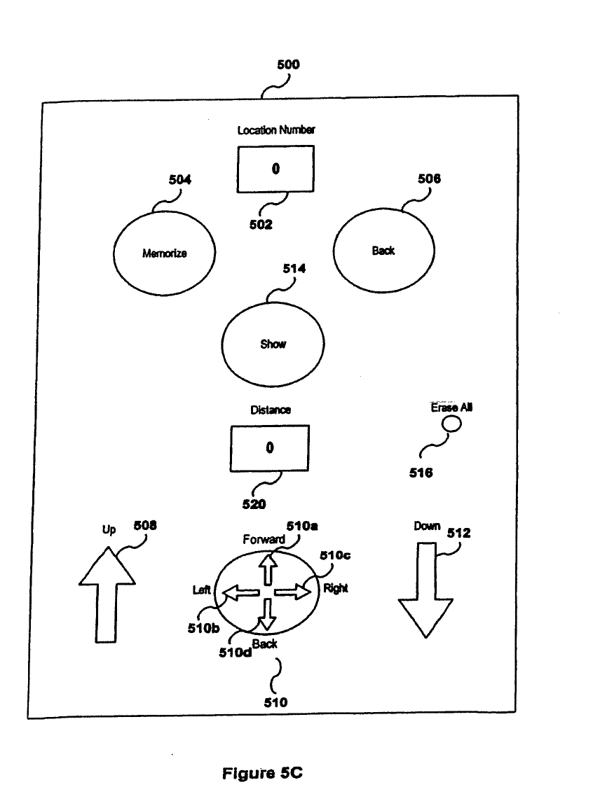

Referring to FIG. 5A, an alternate embodiment of the location device incorporating a simple route-tracking mechanism is shown. According to this embodiment, multiple locations may be registered by a user. Each registered location is associated with a unique location number that is visually represented in Location Number display 502. The first registered location, also referred to as the starting location, is identified by a location number of 0. Memorize button 504 stores the location number, the current location, and the direction that a user is currently facing. The location number is then automatically incremented. Back button 506 decrements the location number and retrieves its associated registered location and direction. By repeatedly pressing Back button 506, the user is able to rotate through each of the stored locations. Show button 514 activates the relative three-dimensional directional indicators (508, 510, and 512) which thereafter light up as necessary to direct a user towards a registered location. While the user is being directed towards a registered location, the light intensity of the directional indicators (508, 510, and 512) is varied, if necessary, to indicate a primary heading. For example, where a user facing north is being directed in a North-North-East direction, the forward 510a and right 510c directional indicators are simultaneously illuminated with forward 510a having a greater light intensity than right 510c, thereby providing the user with a visual indication of a primarily northern heading. Directional indicators 510 (forward 510a, left 510b, right 510c, back 510d) light up simultaneously when the user has arrived at a registered location. Because the registered location may only be accurate to within several feet or more, the original direction that the user was facing when the Memorize button 504 was pressed may be helpful in locating an exact location. Thus, upon arrival to a registered location, Facing Direction indicator 518 illuminates when the user faces the original direction registered when Memorize button 504 was pressed. Determining whether the user is facing the same registered direction may be implemented using a conventional internal compass configured to determine a direction relative to a magnetic north, not shown. Alternatively, as shown in FIG. 5B, directional indicators 510 (forward 510a, left 510b, right 510c, back 510d) flash one or more times when the user has arrived at a registered location and additionally light up as necessary to indicate the original direction registered when Memorize button 504 was pressed. The Erase All button 516 allows the user to clear all previously stored locations and acts as a reset. When the user presses the optional Erase All button 516 longer than some predetermined time, such as two seconds, all previously stored locations are cleared and the location number is set to 0. Additionally, a reset is performed when the user uses the Back button 506 to go back to the starting location and then presses Memorize button 504, thereby eliminating the need for Erase All button 516. Further, as shown in FIG. 5C, the location device may be configured with a distance display 520 to display the distance to a registered location. In this configuration, distance display 520 indicates 0 when the user has arrived at a registered location. Additionally, a location may be registered automatically in response to the engine of the automobile being shutoff. This location will be the location of the device shown in FIG. 5A. The location device of FIG. 5A may receive the location from the automobile, which is programmed to transmit a signal when the engine is shutoff. The transmission may be done by using Bluetooth or another wireless communication protocol. Thus, in one embodiment, the location of the automobile (i.e., the location of the location device when the engine of the automobile is shutoff) is the first location registered/stored in the device. In another embodiment, the location of the automobile is not first. The user may subsequently add the location of the automobile to the location device.

Although the interface is described in terms of the buttons, the operation can be done using the voice command. Also, the response can be voice response instead of the arrows. Therefore, a person can not only register the location, he can register a short message when memorizing a location so that the location number and his voice can be associated.

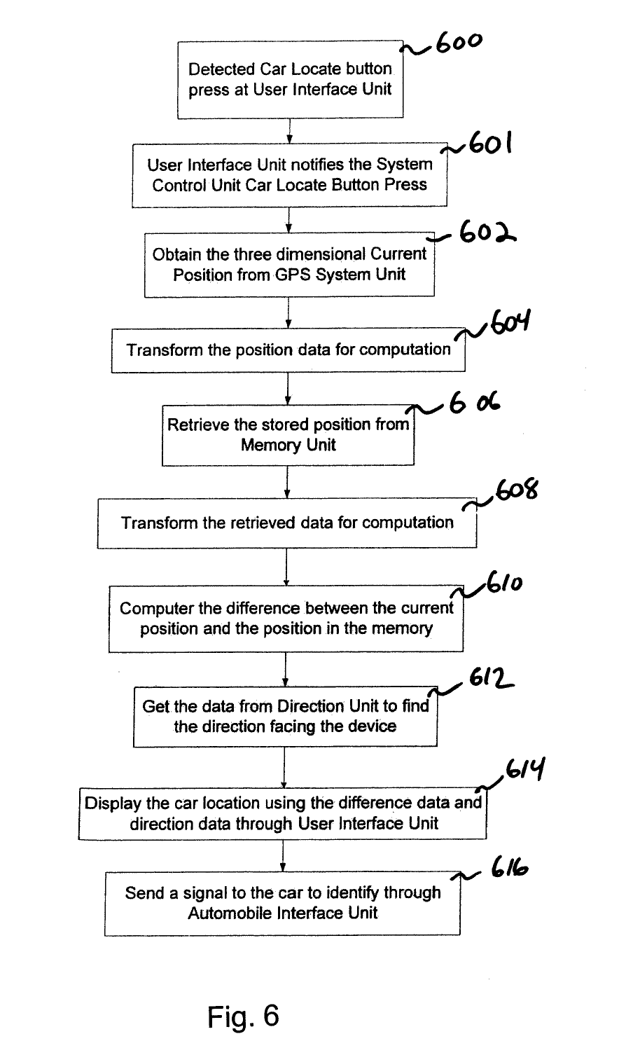

FIG. 6 is a flow chart of an exemplary process of locating a vehicle. At step 600, the user interface unit 108 detects the car locate button being pressed. The user interface unit 108 then notifies the system control unit 110 of the request to locate the vehicle in step 601. Then, the system control unit 110 obtains, at step 402, the three-dimensional current position of from the GPS system unit 102, similar to step 404. At step 604, the system control unit 110 transforms the obtained position data for the computation. At step 406, the system control unit retrieves the stored position data from memory unit 104. The system control unit 110, then, transforms the retrieved data for the computation to find the direction to the vehicle at step 608. At step 610, the system control unit 110 utilizes computation unit 106 to obtain the direction to the vehicle. From the direction unit 112, the system control unit 110 obtains the relative direction that device 100 is facing in step 612. The information can be a north vector relative to the top of the device 100. The system control unit then sends a display message, with the vehicle location information, the direction information, and the user interface unit displays the direction to the vehicle in step 614. The direction information may be displayed for a predetermined time (i.e., two or three seconds) to allow the user to view the direction. At step 616, the system control unit sends a command to the vehicle interface unit to send a signal to the vehicle at step 616. The signal will cause the vehicle to blow its horn, or flash its lights if the vehicle is within range to receive the signal.

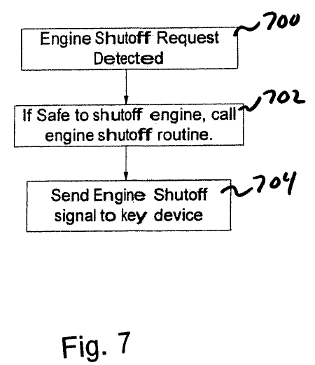

FIG. 7 is flow chart of an exemplary process for an engine shutoff sequence of a vehicle. When engine shutoff is requested by the pressing of the start/off button or switch, the vehicle goes through the steps shown in FIG. 7. A step 700, the engine shutoff request is detected by the vehicle. In step 702, the computer of the vehicle calls an engine shutoff routine if it the computer determines that it is safe to shutoff the engine. In step 704, a signal is sent to the electronic key or remote access device that the engine is shut off and to record the present location.

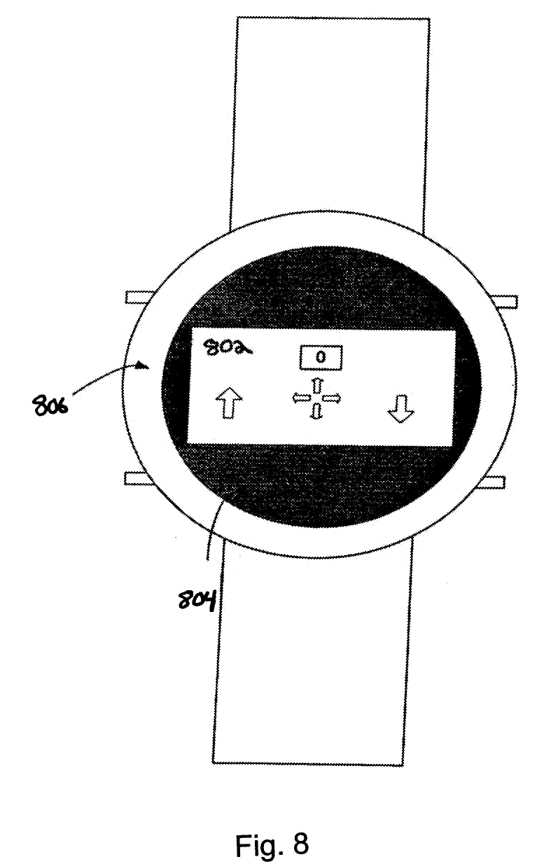

FIG. 8 s an example of an alternative embodiment of the present invention in a wrist device or in a watch. In the wrist device, an LED can be used for the direction indicators. In the watch, one of the buttons sticking out is a control button similar to the watches from Casio. One of the buttons is a mode switch button to switch from clock mode to return location mode and to show the display 802. Area 804 is a solar panel. The other buttons can control the different functions described in conjunction with FIGS. 5A-5C. Another button can be added to control the lighting of the display for night use.

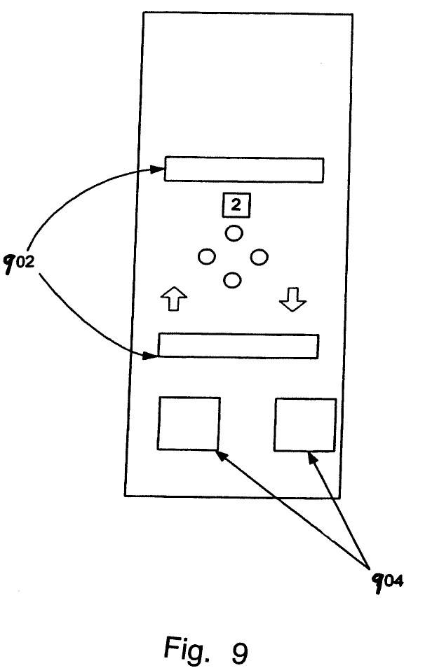

FIG. 9 is another example of an alternative embodiment of the present invention in a bracelet. Devices 902 are solar panels. Buttons 904 are two of the multiple buttons. Note that the implementation in a bracelet allows the use of a solar panel. In addition, an alternative design may hide the buttons and display into some decorative elements.

The present invention may also be embodied as a computer readable storage medium or memory for holding instructions programmed according to the teachings of the invention and for containing data structures, tables, records, or other data described herein. Examples of computer readable media are compact discs, DVDs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling device 100, for driving components of device 100 for implementing the invention, and for enabling device 100 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Obviously, numerous modifications and variations of the present invention are possible in light of the above teachings. It is therefore to be understood that within the scope of the appended claims, the invention may be practiced otherwise than as specifically described herein.

1. A location apparatus for guiding a user to a location, comprising:
a system unit configured to determine a current location using radio signals;
a user interface unit having a display area and a button;
a memory unit;
a processor configured store a first location in the memory unit in response to receiving a signal from a vehicle indicating that an engine of the vehicle is off, and
a computational unit configured to interact with the button, wherein the computation unit retrieves a second location from the system unit and calculates a relative three-dimensional direction from the second location to the first location upon selection of the second button by the user,
wherein the relative three-dimensional direction is graphically represented on the display area of the user interface unit.

2. The location apparatus according to claim 1, wherein the radio signals comprise Global Positional System (GPS) orbiting space satellite signals.

3. The location apparatus according to claim 2, wherein the display area of the user interface unit includes left, right, forward, back, up, and down indicators to represent the relative three-dimensional direction.

4. The location apparatus according to claim 2, wherein, upon selection of the button by the user, the computation unit for a predetermined duration repeatedly retrieves the current location from the system unit, calculates a relative three-dimensional direction from the current location to the first location, and graphically represents the three-dimensional direction on the display area of the user interface unit.

5. The location apparatus according to claim 2, wherein the apparatus is handheld.

6. The location apparatus according to claim 5, wherein the location apparatus is incorporated into an electronic vehicle key, remote access device, a watch, or a bracelet.

7. The location apparatus according to claim 5, wherein the location apparatus is incorporated into a cellular telephone.

8. A method for guiding a user to a location, comprising:
storing a first location in a memory unit in response to receiving a signal from a vehicle indicating that an engine of the vehicle is off;
determining a second location;
calculating a relative three-dimensional direction from the second location to the first location; and
graphically representing a relative three-dimensional direction on a display device.

9. The method of claim 9, further comprising:
transmitting a signal to the vehicle to cause the vehicle to honk its horn or flash a light.

10. The method of claim 9, wherein the graphically representing comprises displaying one or more than one of a left, right, forward, back, up, and down indicators to represent the relative three-dimensional direction.

11. The method of claim 9, further comprising:
determining a current location; and
calculating a relative three-dimensional direction from the current location to the first location.

12. A computer readable storage medium, encoded with instructions which when executed by a computer causes the computer to implement a method for guiding a user to a location, comprising:
storing a first location in a memory unit in response to receiving a signal from a vehicle indicating that an engine of the vehicle is off; and
determining a second location;
calculating a relative three-dimensional direction from the second location to the first location; and
graphically representing a relative three-dimensional direction on a display device.

13. The computer readable medium of claim 12, wherein the method further comprises:
transmitting a signal to the vehicle to cause the vehicle to honk its horn or flash a light.

14. The computer readable medium of claim 12, wherein the graphically representing comprises displaying one or more than one of a left, right, forward, back, up, and down indicators to represent the relative three-dimensional direction.

15. The computer readable medium of claim 12, wherein the method further comprises:
determining a current location; and
calculating a relative three-dimensional direction from the current location to the first location.
